(19) United States
(12) Patent Application Publication
(10) Pub. No.: US 2015/0321911 A1
(43) Pub. Date: Nov. 12, 2015

(54) SILICON POWDER COMPOSITION, METHOD, REACTOR AND DEVICE FOR PRODUCING HYDROGEN

(71) Applicant: Ke JIN, (US)

(72) Inventor: Ke JIN, Shanghai (CN)

(21) Appl. No.: 14/440,955

(22) PCT Filed: Nov. 1, 2013
(86) PCT No.: PCT/CN2013/086411

§ 371 Date: May 6, 2015

(30) Foreign Application Priority Data
Nov. 30, 2012 (CN) 201210504499.0

(51) Int. Cl. C01B 3/06; B01J 19/00; B01J 8/00

(52) U.S. Cl. CPC C01B 3/06; B01J 8/008; B01J 19/0013; B01J 2208/00805; B01J 2219/00121; B01J 2219/00155

(57) ABSTRACT

A silicon powder composition, method, reactor and device for producing hydrogen. Silicon powder composition includes silicon powder, precipitation agent and alkaline substance; wherein alkaline substance is a weak acid salt of alkali metal; mass ratio of alkaline substance to silicon powder is greater than or equal to 0.06:1 and less than or equal to 4:1; silicon powder is a silicon powder with average particle diameter of less than or equal to 1 mm; molar stoichiometric ratio of precipitation agent to silicon in the silicon powder is greater than or equal to 0.12:1 and less than or equal to 4:1. Also presented is a method and reactor for producing hydrogen, and reaction device for producing hydrogen. Silicon powder composition of invention is an optimized formulation which needs no pre-treatment, contains no highly corrosive alkalis, and does not easily burn or explode. Reactor structure and device of invention have relatively high practicability.

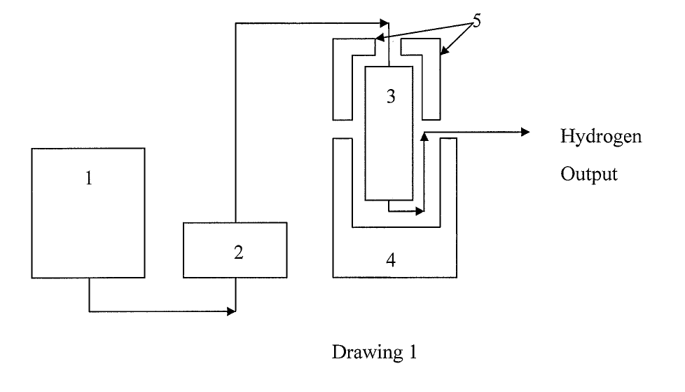

### TECHNOLOGY FIELD

The present invention specifically relates to a silicon powder composition, method, reactor and device for producing hydrogen.

### BACKGROUND OF THE INVENTION

Hydrogen is a new energy with good prospects. But the high density storage/transportation of hydrogen involves quite many technological bottlenecks. An alternative method is chemically producing hydrogen on the spot to fulfil application requirements.

Producing hydrogen with the chemical reaction of metal hydrides, provides high energy density, such as LiH+H₂O═LiOH+H₂, NaBH₄+4H₂O═NaB(OH)₄+4H₂. But metal hydrides are typically quite expensive and toxic, thus are only suitable for military application, not civil.

Silicon can react with strong alkali solution and produce hydrogen, Si+2NaOH+(l+n)H₂O═Na₂SiO₃.nH₂O+2H₂. Silicon is cheap and environment friendly, but its reaction with strong alkali solution is too violent to be controlled; furthermore, in order to fully react the silicon, adequate stoichiometric ratio of strong alkali is required, thus the cost is increased and the environment protection is decreased. It was reported that in a folk workshop, ferro-silicon alloy, sodium-hydroxide and water were placed in a pressure tank to produce hydrogen for toy balloons filling, and then the uncontrolled reaction caused explosion and casualty.

Chinese patent application 201110076118.9 provided a silicon powder composition for producing hydrogen, wherein comprises silidous powder, the chemical compound of a metal element which can form the silicate with solubility in water less than 1%, and alkaline substance; the silicon powder composition can smoothly producing hydrogen while contacting water; and the hydrogen produced can be transferred into energy. This technology pointed out a reasonable direction, but still not enough for real application; also it had not adequately tested the quantitative parameters such as reaction yield ratio to theoretical limitation.

### CONTENTS OF THE INVENTION

The present invention is purposed to overcome the distance to real application of the existing silicon powder composition hydrogen producing technology, and provides a silicon powder composition, method, reactor and device for producing hydrogen. The silicon powder composition of present invention is an optimized formula which needs no pretreatment, comprises no strong corrosive alkali, not easy to combusts/explodes while contacting water due to improper storage. The reactor structure and device of present invention are also highly practical.

The present inventor carefully researched the background technology 201110076118.9 and believes:

Even though The precipitation agent such as Ca(OH)₂ can revive the NaOH, thereby reduce the dosage of NaOH to less than stoichiometric ratio, but the dosage is still not low, thus the environment protection of composition is still not perfect.

The essence of NaOH can be regarded as Na₂O.H₂O, thus contains “hidden crystal water”. The existing of “hidden crystal water” causes quite violent reaction while the composition initially contacts a little water. Thus the application system requires a reactor withstanding high temperature caused by violent reaction, which increases the cost of reactor enclosure; and requires a buffer container to store the over amount of hydrogen produced in short time; Further, the violent reaction causes great flow rate in short time and pushes the movement of composition powder, breaks the stability of reactor's internal structure. If we settle this problem with high temperature pretreatment on the composition, the manufacturing cost is increased; the hydrogen storage weight density is reduced; and the silicon powder is partially wasted.

Also, the background technology only provides composition formula, no reactor structure nor device; this means the distance to real application.

In order to solve said technology problems, the present invention provides following technology solutions:

Firstly provided is a silicon powder composition for producing hydrogen wherein: comprises silicon powder, precipitation agent and alkaline substance; Said alkaline substance is the weak acid salt of alkali metal; The mass ratio of said alkaline substance to the silicon in the silicon powder is 0.06:1˜4:1; further prefers 0.12:1˜2:1; most prefers 0.25:1˜1:1; Said silicon powder is the silicon powder with average particle diameter of less than or equal to 1 mm. The molar stoichiometric ratio of said precipitation agent to the silicon in the silicon powder, is greater than or equal to 0.12:1, and less than or equal to 4:1.

The selecting on weak acid salt of alkali metal has following advantages:

A, eliminates the “hidden crystal water”, avoids the initial violent reaction without pretreatment on high temperature; thus no increase on manufacturing cost, no decrease on hydrogen storage weight density, no partial waste on silicon powder.

B, the alkalinity is far lower than NaOH, the corrosivity is greatly reduced, thus is relatively good on environment protection.

C, because of the lower alkalinity than NaOH, and some other reasons, the water contacting of the composition in normal temperature, will not easily initiate reaction; short time preheating is necessary at the beginning, but not necessary after the reaction is initiated and the reaction heat maintains the temperature. This feature slightly increases the system complexity, but greatly improves the composition safety; while contacting normal temperature water due to improper storage/transportation, especially large amount of normal temperature water, it is not easy to produce large amount of hydrogen and cause combustion/explosion.

In the present invention, the alkali metal of said “weak acid salt of alkali metal” further prefers Na and/or K; especially Na provides lower cost and better availability.

In the present invention, the pKa (in normal temperature 25° C.) of the weak acid of said “weak acid salt of alkali metal”, further prefers greater than 9.50 and less than 13.00; In case the weak acid has multiple pKa, the maximum pKa is the benchmark. The alkali metal salt of weak acid with pKa less than 13, comparing to those with pKa greater than 13, has lower alkalinity and better environment protection, lower market price (one reason is lower cost for environment protection in production process), lower hygroscopicity and better dryness/stability in storage/transportation. The alkali metal salt of weak acid with pKa greater than 9.5, comparing to those with pKa less than 9.5, is more active in reaction. Said weak acid, further prefers meta-aluminic acid (pKa=12.20), meta-silicic acid (pKa=11.80), carbonic acid (pKa=10.25), or the mixture thereof. The most preferred is carbonic acid, which has very weak alkalinity, very low cost, and is popularly used in food industry thus best on environment protection. Further, the acid radical of said three further preferred weak acid, together with Ca ion in the precipitation agent of example, form salts with solubility in water less than 1%; Ca(AlO₂)₂ is the main component of high alumina cement; CaSiO₃ is the main component of normal cement; CaCO₃ is the main component of marble. This can slightly improve the alkalinity, thus avoids too weak alkalinity initially.

It is necessary to clarify, that the background technology 201110076118.9 also mentioned NaAlO₂, but as precipitation agent. Since the inventor of background technology was unaware of that NaAlO₂ may serves as preferred alkaline substance, and used NaOH aside as alkaline substance while using NaAlO₂ as precipitation agent, thus can't achieve the optimized result of present invention.

For further interesting information, an example of present invention, wherein NaAlO₂ serves as both alkaline substance and precipitation agent, discovers that NaAlO₂ is not the further preferred precipitation agent. The present inventor tries to analyze this in theory, and thinks that aluminum ion can well precipitate SiO₃²⁻ in neutral environment, but maybe not so excellent in alkaline environment.

In the present invention, said precipitation agent is metal compound, wherein: the silicate of said metal has solubility in water less than 1 gram/100 gram; said metal compound can ionize in water. Such as (but not limited in) metal oxide, metal hydroxide, or the mixture thereof. Said metal may be (but not limited in) Ca, Mg, Fe, Al, or the mixture thereof; further preferred as Ca.

In the present invention, the molar stoichiometric ratio of the metal element in said precipitation agent to the silicon in said silicon powder, is further preferred as 0.25:1˜2:1, most preferred as 0.5:1˜1:1.

Preferably, in the present invention, the salt formed by the acid radical of said alkali metal weak acid salt and the metal element in said precipitation agent, has solubility in water less than 1 gram/100 gram.

In the present invention, the purity of silicon in said silicon powder may be at least 25% (w/w), preferred as greater than or equal to 50% (w/w), further preferred as greater than or equal to 90% (w/w). Thus said silicon powder may be silicon alloy powder, for example ferro-silicon alloy powder (the deoxidizing agent for iron/steel industry), with typical silicon purity of 70˜80%, has some cost advantage. However, silicon alloy drops weight density of hydrogen production while reducing cost. The silicon alloy powder with further less silicon purity is not commercially available, but the result can be speculated from the examples of present invention. While the silicon purity is less than 25%, the weight density of hydrogen production and practicability will be very low.

The average particle diameter of said silicon powder is preferred as less than or equal to 0.3 mm, further preferred as less than or equal to 0.1 mm. Not only because of the normal chemical knowledge that fine powder has good chemical activity, but also that the fine powder has less bulk density and greater bulk volume, thus prevents the expansion of composition during reaction, and is convenient to be filled in fixed bed reactor, which is more practicable. However, the average particle diameter is further preferred as greater than 0.01 mm, or otherwise the machining cost will rapidly rise.

In the present invention, said composition may be in the form of suit composition before mixing the components, or in the form after mixing the components. The composition may also comprise a little water, or the reaction product of water, alkaline substance and silicon. For example, alkaline substance may absorb moisture in some cases, thereafter the small amount of water reacts with alkaline substance and silicon, forms a composition comprising the reaction product thereof; this composition is also reasonably covered by the present invention.

The present invention also provides a method for producing hydrogen, wherein comprises following processes: in the reaction temperature of 40° C.˜160° C., reacts said silicon powder composition with water.

Wherein said reaction temperature is preferred as 80° C.˜120° C. Preferably, said method comprises following processes: contacts said composition in the temperature of 40° C.˜160° C. (preferred as 80° C.˜120° C.) with water and reacts.

In most of the examples of present invention, hot water above 90° C. is applied to soak the reactor and thereby initiate the reaction, initial temperature of 80˜100° C. is proved to be appropriate. In the following running phase, because of the effect of thermal insulation cover, the reaction heat is mainly brought out by the evaporation of water; further because of the boiling point above 100° C. for dense solution, the internal temperature of reactor may reaches 100˜120° C. The temperature effect to thermodynamic activity is gradual instead of transilient, while the dosage of alkaline substance is more and the alkalinity is stronger, the range of 40˜80° C. can also initiate the reaction, but is not preferred. With similar reason, while the dosage of alkaline substance is more and the regional concentration is greater, the boiling point of dense solution may reach 120˜160° C. Further, the real application may need large reactor with greater mass flow rate; in order to reduce fluid resistance, the reactor operation pressure may be increased for less volume flow rate, in this case the boiling point of pure water may reach 120° C. or above, of dense solution may reach 120˜160° C. While the reactor operation pressure (gauge pressure) is 1˜9 Bar, the hydrogen volume flow rate drops to 0.5˜0.1 times, the fluid resistance is adequately reduced; further greater pressure may increase the weight, volume and cost of reactor enclosure, thus is not preferred.

The present invention further provides a reactor, wherein said reactor comprises said composition of present invention; the components, dosages and preferred conditions are same to those hereinbefore; said reactor is equipped with water input port and hydrogen output port.

Preferably, the water input port and hydrogen output port of said reactor are not on a same plane. Preferably, said reactor is cylindrical.

Said reactor may be equipped with dismountable port; this port may be applied to connecting the matching port of other device. Other solid container, for example, may be dismounted through this port.

The present invention loads said composition in closed and compact reactor, comparing to the beaker of background technology 201110076118.9, greatly improves practicability; especially in case of applying cheap disposable material for reactor enclosure, replacing disposable reactor on reaction device, will be convenient as replacing battery. The composition and method of present invention, reacts smoothly without explosive great flow rate impact in short time, thus is appropriate to closed and compact reactor structure; also, the reaction temperature is not too high, thus cheap material is appropriate for reactor enclosure. Referring to the comparative examples, these two points are clear.

The present invention further provides a reaction device for producing hydrogen, wherein comprises said reactor and a liquid container; said liquid container is directly or indirectly connected to the reactor; said connection is fixed or dismountable connection.

Said liquid container, may be liquid tube.

Said reaction device, may also comprise a heater. Said heater, is preferred to be close to or embedded in said reactor.

Said reaction device, may comprise a thermal insulation cover enveloping said reactor.

Preferably, said reactor and liquid container are connected through a liquid pump. Said liquid pump is volume type or momentum type, prefers volume type, further prefers peristaltic pump. By liquid pump, the speed of hydrous liquid from the liquid container entering the reactor is controlled.

Based on the common knowledge of present field, the preferred conditions mentioned hereinbefore may be combined at random, then get the examples of present invention.

The reagents and materials applied in present invention are all commercially available.

The positive improvements and effects of present invention is that, the reaction for producing hydrogen with the composition of present invention is steady and controllable; the reactor is closed and compact; also is highly environment protective, highly safe and highly practicable.

### BRIEF DESCRIPTION OF THE DRAWINGS

Drawing 1 is the device for producing hydrogen applied in the specific embodiments. Wherein 1 is liquid container, 2 is liquid pump, 3 is reactor, 4 is heater, 5 is thermal insulation cover. The arrow direction is the direction of fluid flow and hydrogen output.

### SPECIFIC EMBODIMENTS

With following examples, the present invention is further explained, but not limited in the range thereof. The experimental methods without marked with specific conditions in following examples, comply with normal methods and conditions, or comply with commodity specification.

The materials related to the present invention are all commercially available:

| Item | Specification | Supplier |
|---|---|---|
| silicon powder | purity 99%; mesh 200 | Shandong Huahao Silicon, |
| | passed | China |
| ferro-silicon | purity 70%; between | Shanghai Xinxing, China |
| alloy powder | mesh 80 to mesh 200 | |
| silicon powder | purity 99%; selected | Shandong Huahao Silicon, |
| | average particle | China |
| | diameter about 0.3 mm | |
| silicon powder | purity 99%; selected | Shandong Huahao Silicon, |
| | average particle | China |
| | diameter about 1.0 mm | |
| NaAlO₂ | chemically pure, | Guoyao Group Chemical |
| | powder | Reagent Co. Ltd. China |
| Na₂SiO₃ | purity 97%; powder | Qingdao Dongyue Sodium |
| | | Silicate Co. Ltd. China |
| Na₂CO₃ | analytically pure; | Guoyao Group Chemical |
| | powder | Reagent Co. Ltd. China |
| NaHCO₃ | analytically pure; | Shanghai Linfen Chemical |
| | powder | Reagent Co. Ltd. China |
| Na₄SiO₄ | Purity above 87%, | Qingdao Dongyue Sodium |
| | powder | Silicate Co. Ltd. China |
| K₂CO₃ | analytically pure; | Shanghai Linfen Chemical |
| | powder | Reagent Co. Ltd. China |
| NaOH | bead, diameter | Shanghai Shengwan Fine |
| | 0.5~1.0 mm | Chemical, China |
| CaO | analytically pure; | Shanghai Linfen Chemical |
| | broken to powder and | Reagent Co. Ltd. China |
| | pass mesh 50. | |
| Ca(OH)₂ | analytically pure; | Shanghai Linfen Chemical |
| | powder about mesh 200 | Reagent Co. Ltd. China |
| MgO | analytically pure; | Shanghai Aibi Chemical |
| | powder about mesh 200 | Reagent Co. Ltd. China |
| FeO(OH) | chemically pure; | Shanghai Runjie Chemical |
| | powder about mesh 100 | Reagent Co. Ltd. China |
| disposable | 10 ml, plastic | Jiangxi Hongda Medical |
| medical | | Equipment Group Co. Ltd. |
| syringe | | China |
| disposable | 100 ml, plastic | Jiangxi Hongda Medical |
| medical | | Equipment Group Co. Ltd. |
| syringe | | China |
| flexurane | Open cell, specific | Shanghai Zhengyang Foam |
| foamed plastic, | weight 0.06, cell | Co. Ltd. China |
| high temperature | density about 80 PPI | |
| proof modified | | |

The common points of all examples:

In all the following examples, a beaker containing water serves as liquid container 1, a peristaltic pump serves as liquid pump 2, said disposable medical syringe filled with said composition serves as reactor 3, a beaker containing hot water above 90° C. serves as heater 4, thermal insulation material (flexurane foamed plastic, high temperature proof modified) is cut into thermal insulation cover 5 with thickness at least 10 mm. Refer to drawing 1.

The enclosure of plastic disposable medical syringe serves as the enclosure of reactor. The needle is not applied; the port on enclosure for connecting needle serves as water input port, and is connected to the water output port of peristaltic pump. Pull out the push rod, take down the rubber piston on it, and then fill in the original inlet of said push rod, so that it serves as the sealing plug of hydrogen output port. A hole is opened in the center of rubber piston, and serves as the hydrogen output port.

The composition is filled in said reactor enclosure, close to the water input port; filtering material (flexurane foamed plastic, high temperature proof modified) is cut to appropriate dimension and pushed in said syringe and compressed the composition.

During the reaction process, said reactor is vertically placed, with the water input port upward, and the hydrogen output port downward.

Without special description, the flow rate of peristaltic pump is 0.02 g/min.

Without special description, the silicon powder is mesh 200 passed.

The method of measuring hydrogen yield is water volume pushing out. The environment temperature is room temperature.

In some of the examples, while initiating the reaction, the reactor is soaked in the heater; thereafter it is take out from the heater and enveloped by the thermal insulation cover, so as to reduce the leakage of reaction heat and ensure the reaction temperature high enough.

During the reaction process, a portion of water absorbs the reaction heat and evaporates to steam, flows out with hydrogen. Thus the water input flow rate is not in strict stoichiometry ratio to the hydrogen output flow rate.

### Example 1

Evenly mix 1.05 g silicon powder (about 3/80 MOL), 2.1 g CaO (about 3/80 MOL) and 0.5 g NaAlO₂; fill in a 10 ml syringe, and the scale displayed volume of composition is about 4.5 cc.

In the beginning 15 min, heater is applied, and then it is replaced by thermal insulation cover.

The hydrogen yield volume is recorded per 30 min, 130 cc\160 cc\210 cc\220 cc\210 cc\210 cc\180 cc\130 cc in sequence, then stops due to remarkable dropping of flow rate.

The total hydrogen yield is 1450 cc, the ratio to theoretical limitation is 86.3%.

### Example 2

Evenly mix 1.05 g silicon powder (about 3/80 MOL), 2.1 g CaO (about 3/80 MOL) and 0.5 g Na₂SiO₃; fill in a 10 ml syringe, and the scale displayed volume of composition is about 4.0 cc.

In the beginning 15 min, heater is applied, and then it is replaced by thermal insulation cover.

The hydrogen yield volume is recorded per 30 min, 80 cc\140 cc\220 cc\230 cc\230 cc\180 cc\200 cc\130 cc in sequence, then stops due to remarkable dropping of flow rate.

The total hydrogen yield is 1410 cc, the ratio to theoretical limitation is 83.9%.

### Example 3

Evenly mix 1.05 g silicon powder (about 3/80 MOL), 2.1 g CaO (about 3/80 MOL) and 0.5 g Na₂CO₃; fill in a 10 ml syringe, and the scale displayed volume of composition is about 4.0 cc.

In the beginning 15 min, heater is applied, and then it is replaced by thermal insulation cover.

The hydrogen yield volume is recorded per 30 min, 80 cc\160 cc\240 cc\240 cc\240 cc\220 cc\190 cc\70 cc in sequence, then stops due to remarkable dropping of flow rate.

The total hydrogen yield is 1440 cc, the ratio to theoretical limitation is 85.7%.

### Example 4

Evenly mix 1.05 g silicon powder (about 3/80 MOL) and 2.05 g NaAlO₂ (about 1/40 MOL, following the stoichiometric ratio to form Al₂(SiO₃)₃); fill in a 10 ml syringe, and the scale displayed volume of composition is about 4.0 cc.

In the beginning 15 min, heater is applied, and then it is replaced by thermal insulation cover.

The hydrogen yield volume is recorded per 30 min, 380 cc\220 cc\140 cc in sequence, then stops due to remarkable dropping of flow rate.

The total hydrogen yield is 740 cc, the ratio to theoretical limitation is 44%. Thus, even though NaAlO₂ is an alkaline substance further preferred, but not a precipitation agent further preferred.

### Example 5

Evenly mix 10.5 g silicon powder (about 3/8 MOL), 21 g CaO (about 3/8 MOL) and 5 g NaAlO₂; fill in a 100 ml syringe, and the scale displayed volume of composition is about 45 cc.

The flow rate of peristaltic pump is 0.18 g/min.

In the beginning 5 min, heater is applied, and then removed, but without applying thermal insulation cover. Because the dimension of reactor is greater than the former examples, the ratio of thermal dissipation surface area to the composition reaction volume is reduced, thus the thermal dissipation through enclosure affects less.

The hydrogen yield volume is recorded per 30 min, 1.19 L\1.58 L\2.11 L\2.14 L\2.05 L\1.92 L\1.80 L\1.54 L\1.31 L in sequence, then stops due to remarkable dropping of flow rate.

The total hydrogen yield is 15.64 L, the ratio to theoretical limitation is 93.1%. Comparing to example 1, the formula proportion remains same, the dosage times 10, the water flow rate times 9, the yield percentage improves remarkably.

### Example 6

Evenly mix 1.05 g silicon powder, 1.05 g Ca(OH)₂ and alkaline substance; fill in a 10 ml syringe, and the scale displayed volume of composition is about 4.0 cc. In the 2 sub examples, the alkaline substances are 0.5 g NaAlO₂, 0.5 g Na₂CO₃ respectively.

Neither heater nor thermal insulation cover is applied.

In both of the sub examples, the peristaltic pump run 30 min, nearly no remarkable hydrogen yield are observed; then the peristaltic pump stop and keep static for 30 min, still the same.

Thus, the reaction can't be initiated without being heated. While contacting water due to improper storage/transportation, the composition of present invention is not easy to react and produce flammable hydrogen, thus is highly safe.

For further explanation, the precipitation agent in present example is Ca(OH)₂, which is mainly applied in background technology 201110076118.9. In case of applying CaO as precipitation agent, such as other examples of present invention, the less molar mass is an advantage; however CaO creates some hydration heat while combining with water and increases the temperature of composition, thus is still possible to initiate the reaction from room temperature and the safety level is slightly lower than the case of Ca(OH)₂.

### Example 7

Evenly mix 1.05 g silicon powder (about 3/80 MOL), 2.1 g CaO (about 3/80 MOL) and alkaline substance; fill in a 10 ml syringe, and the scale displayed volume of composition is about 3.7˜4.0 cc. In the 4 sub examples, the alkaline substances are 0.15 g NaAlO₂, 0.15 g Na₂SiO₃, 0.15 g Na₂CO₃, 0.25 g NaHCO₃ respectively.

In the beginning 15 min, heater is applied, and then it is replaced by thermal insulation cover.

The hydrogen yield volume is recorded per 30 min, and stops while remarkable dropping of flow rate.

Following are the 30 min hydrogen yield, total hydrogen yield and the ratio to theoretical limitation of the 4 sub examples:

Sub example 1: 90 cc\210 cc\230 cc\210 cc\180 cc\120 cc, 1040 cc, 61.9%.

Sub example 2: 80 cc\160 cc\220 cc\190 cc\160 cc\100 cc, 910 cc, 54.2%.

Sub example 3: 60 cc\130 cc\180 cc\200 cc\170 cc\80 cc, 820 cc, 48.8%.

Sub example 4: 70 cc\130 cc\210 cc\230 cc\220 cc\190 cc\60 cc, 1110 cc, 66.1%.

### Example 8

The present example is purposed to explore the lower limitation of dosage for the precipitation agent.

Evenly mix 1.05 g silicon powder (about 3/80 MOL), precipitation agent and 0.5 g NaAlO₂; fill in a 10 ml syringe. In the 3 sub examples, the precipitation agents are 1.4 g/0.7 g/0.35 g (about 3/160 MOL, 3/320 MOL, 3/640 MOL) Ca(OH)₂ respectively, and the scale displayed volume of composition are about 5.2 cc/3.4 cc/2.8 cc.

In the beginning 15 min, heater is applied, and then it is replaced by thermal insulation cover.

The hydrogen yield volume is recorded per 30 min, and stops while remarkable dropping of flow rate.

Following are the 30 min hydrogen yield, total hydrogen yield and the ratio to theoretical limitation of the 3 sub examples:

Sub example 1: 230 cc\190 cc\200 cc\190 cc\180 cc\100 cc, 1090 cc, 64.9%.

Sub example 2: 280 cc\210 cc\230 cc\200 cc\130 cc, 1050 cc, 62.5%.

Sub example 3: 270 cc\230 cc\220 cc\130 cc, 850 cc, 50.6%.

### Example 9

The present example is purposed to explore the upper limitation of dosage for the precipitation agent and alkaline substance.

Evenly mix 1.05 g silicon powder (about 3/80 MOL), precipitation agent and alkaline substance; fill in a 10 ml syringe. Following are the formula and volume of the 3 sub examples:

Sub example 1: 4.2 g CaO(about 3/40 MOL)\1.0 g Na₂CO₃\5.5 cc.

Sub example 2: 4.2 g CaO(about 3/40 MOL)\2.0 g Na₂CO₃\6.4 cc.

Sub example 3: 8.4 g CaO(about 3/20 MOL)\4.0 g Na₂CO₃\11 cc.

In the beginning 30 min, heater is applied, and then it is replaced by thermal insulation cover.

The hydrogen yield volume is recorded per 30 min, and stops while remarkable dropping of flow rate.

Following are the 30 min hydrogen yield, total hydrogen yield and the ratio to theoretical limitation of the 3 sub examples:
Sub example 1: 50\100\130\150\170\190\200\190\180\160, 1520 cc, 90.5%.
Sub example 2: 40\110\150\150\160\180\200\190\180\150, 1510 cc, 89.9%.
Sub example 3: 50\90\90\90\100\90\100\90\90\80\80\80\80\80\70, 1260 cc, 75%.

### Example 10

The present example is purposed to explore the lower limitation of dosage for the alkaline substance.

Evenly mix 1.05 g silicon powder (about 3/80 MOL), 1.2 g CaO plus 1.2 g Ca(OH)₂ (totally about 3/80 MOL) and 0.07 g NaAlO₂; fill in a 10 ml syringe, and the scale displayed volume of composition is about 5.0 cc.

Heater is always applied, no need thermal insulation cover.

The hydrogen yield volume is recorded per 30 min, 60 cc\140 cc\130 cc\120 cc \100 cc\100 cc\90 cc\80 cc in sequence, then stops due to remarkable dropping of flow rate.

The total hydrogen yield is 820 cc, the ratio to theoretical limitation is 48.8%.

### Example 11

Evenly mix 1.05 g silicon powder (about 3/80 MOL), 1.5 g MgO (about 3/80 MOL) and 0.5 g NaAlO₂; fill in a 10 ml syringe, and the scale displayed volume of composition is about 5.0 cc.

Heater is always applied, no need thermal insulation cover.

The hydrogen yield volume is recorded per 30 min, 100 cc\140 cc\160 cc\140 cc \140 cc\150 cc\150 cc\130 cc in sequence, then stops due to remarkable dropping of flow rate.

The total hydrogen yield is 1110 cc, the ratio to theoretical limitation is 66.1%.

### Example 12

Evenly mix 1.5 g ferro-silicon alloy powder (about 3/80 MOL of silicon), 2.8 g Ca(OH)₂ (about 3/80 MOL) and 1.0 g NaAlO₂; fill in a 10 ml syringe, and the scale displayed volume of composition is about 6.5 cc.

In the beginning 30 min, heater is applied, and then it is replaced by thermal insulation cover.

The hydrogen yield volume is recorded per 30 min, 150 cc\170 cc\210 cc\200 cc\180 cc\180 cc\90 cc in sequence, then stops due to remarkable dropping of flow rate.

The total hydrogen yield is 1180 cc, the ratio to theoretical limitation is 70.2%.

### Example 13

Evenly mix 1.05 g silicon powder (about 3/80 MOL), 2.2 g FeO(OH) (about 1/40 MOL) and 0.5 g NaAlO₂; fill in a 10 ml syringe, and the scale displayed volume of composition is about 3.7 cc.

Heater is always applied, no need thermal insulation cover.

The hydrogen yield volume is recorded per 30 min, 270 cc\200 cc\190 cc\150 cc \90 cc in sequence, then stops due to remarkable dropping of flow rate.

The total hydrogen yield is 900 cc, the ratio to theoretical limitation is 53.6%.

### Example 14

The present example is purposed to explore the upper limitation of average particle diameter for the silicon powder.

Evenly mix 1.05 g silicon powder, 2.8 g Ca(OH)₂ and 1.0 g alkaline substance; fill in a 10 ml syringe. Following are the average particle diameter of silicon powder, alkaline substance and volume of composition in the 2 sub examples:

Sub example 1: 0.3 mm, Na₂CO₃, 6 cc.

Sub example 2: 1.0 mm, Na₄SiO₄, 5.5 cc.

Heater is always applied, no need thermal insulation cover.

The flow rate of peristaltic pump is 0.01 g/min.

The hydrogen yield volume is recorded per 60 min, and stops while remarkable dropping of flow rate.

Following are the 60 min hydrogen yield, total hydrogen yield and the ratio to theoretical limitation of the 2 sub examples:

Sub example 1: 140\ 190\ 190\ 190\ 180\ 150\ 80, 1120 cc, 66.7%.

Sub example 2: 290\ 190\ 160\ 140\ 110, 890 cc, 53%.

### Example 15

Evenly mix 1.05 g silicon powder, 1.2 g CaO plus 1.2 g Ca(OH)₂ and 1.0 g K₂CO₃; fill in a 10 ml syringe, and the scale displayed volume of composition is about 5.0 cc.

In the beginning 30 min, heater is applied, and then it is replaced by thermal insulation cover.

The hydrogen yield volume is recorded per 30 min, 150 cc\260 cc\270 cc\240 cc\200 cc\160 cc in sequence, then stops due to remarkable dropping of flow rate.

The total hydrogen yield is 1280 cc, the ratio to theoretical limitation is 76.2%.

### Comparative Example 1

Evenly mix 1.4 g silicon powder, 2.8 g CaO and 1.0 g NaOH; fill in the reactor, and the volume of composition is about 6 cc.

Neither heater nor thermal insulation cover is applied.

The flow rate of peristaltic pump is 0.01 g/min.

Nearly no reaction at the beginning; after 5 min, hydrogen is produced and the flow rate increase rapidly; after further 1 min, it reacts violently, pushes down a portion of composition and deforms the packing structure; even through the peristaltic pump is turned off in time, the reaction still continuous some time and yield hydrogen 150 cc.

The plastic enclosure of reactor is slightly melted and deformed.

Thus, while alkali metal hydroxide serves as alkaline substance, the closed and compact reactor with cheap enclosure material of present invention is not appropriate.

### Comparative Example 2

The present example tested the case without said alkaline substance of present invention.

Evenly mix 1.05 g silicon powder (about 3/80 MOL), 1.2 g CaO plus 1.2 g Ca(OH)₂ (totally about 3/80 MOL); fill in a 10 ml syringe, and the scale displayed volume of composition is about 4.7 cc.

Heater is always applied, no need thermal insulation cover.

The hydrogen yield volume is recorded per 30 min, 10 cc\30 cc \30 cc in sequence, then stops due to unpractical flow rate.

### Comparative Example 3

The present example is purposed to explore the case of ultra-low dosage for the alkaline substance.

Evenly mix 1.05 g silicon powder (about 3/80 MOL), 1.2 g CaO plus 1.2 g Ca(OH)₂ (totally about 3/80 MOL) and 0.04 g NaAlO₂; fill in a 10 ml syringe, and the scale displayed volume of composition is about 4.7 cc.

Heater is always applied, no need thermal insulation cover.

The flow rate of peristaltic pump is 0.01 g/min.

The hydrogen yield volume is recorded per 30 min, 10 cc\60 cc\60 cc\50 cc \40 cc\30 cc in sequence, then stops due to remarkable dropping of flow rate.

The hydrogen yield is obviously very low.

The simple transformations well known by the skilled personnel of present field, are all protected by the present invention.

1. A silicon powder composition for producing hydrogen, comprises silicon powder, precipitation agent and alkaline substance; said alkaline substance is the weak acid salt of alkali metal; the mass ratio of said alkaline substance to the silicon in the silicon powder, is greater than or equal to 0.06:1, and less than or equal to 4:1; said silicon powder is the silicon powder with average particle diameter of less than or equal to 1 mm; the molar stoichiometric ratio of said precipitation agent to the silicon in the silicon powder, is greater than or equal to 0.12:1, and less than or equal to 4:1.

2. The silicon powder composition of claim 1, wherein: the mass ratio of said alkaline substance to the silicon in the silicon powder, is greater than or equal to 0.25:1, and less than or equal to 1:1.

3. The silicon powder composition of claim 1, wherein: the alkali metal of said “weak acid salt of alkali metal” is Na and/or K.

4. The silicon powder composition of claim 1, wherein: the pKa in normal temperature 25° C. of the weak acid of said “weak acid salt of alkali metal”, is greater than 9.50 and less than 13.00; in case the weak acid has multiple pKa, the maximum pKa is the benchmark.

5. The silicon powder composition of claim 1, wherein: said weak acid, is meta-aluminic acid, meta-silicic acid, carbonic acid, or the mixture thereof.

6. The silicon powder composition of claim 1, wherein: the salt formed by the acid radical of said alkali metal weak acid salt and the metal element in said precipitation agent, has solubility in water less than 1 gram/100 gram.

7. The silicon powder composition of claim 1, wherein: said precipitation agent is metal oxide, metal hydroxide, or the mixture thereof; the metal element in said precipitation agent is Ca.

8. The silicon powder composition of claim 1, wherein: the purity of silicon in said silicon powder is greater than or equal to 50% (w/w); and/or, the average particle diameter of said silicon powder is less than or equal to 0.3 mm.

9. A method for producing hydrogen comprises in the reaction temperature of 40° C.˜160° C., reacts the silicon powder composition of claim 1 with water.

10. The method of claim 9, wherein: said reaction temperature is 80° C.˜120° C.

11. The method of claim 9, wherein: the pressure (gauge pressure) of said reaction is 1˜9 Bar.

12. A reactor comprises the composition of claim 1; said reactor is equipped with water input port and hydrogen output port.

13. The reactor of claim 12, wherein: the water input port and hydrogen output port of said reactor are not on a same plane; and/or, said reactor is cylindrical.

14. A reaction device for producing hydrogen comprises the reactor of claim 12, and a liquid container; said liquid container is directly or indirectly connected to the reactor; said connection is fixed or dismountable connection.

15. The reaction device of claim 14, wherein: said reaction device, also comprises a heater; and/or, said reaction device, also comprises a thermal insulation cover enveloping said reactor.
